(19) United States
(12) Patent Application Publication
(10) Pub. No.: US 2013/0104014 A1
(43) Pub. Date: Apr. 25, 2013

(54) VIEWER UNIT, SERVER UNIT, DISPLAY CONTROL METHOD, DIGITAL COMIC EDITING METHOD AND NON-TRANSITORY COMPUTER-READABLE MEDIUM

(71) Applicant: FUJIFILM Corporation, Tokyo (JP)

(72) Inventor: Shunichiro NONAKA, Tokyo (JP)

(73) Assignee: FUJIFILM Corporation, Tokyo (JP)

(21) Appl. No.: 13/654,318

(22) Filed: Oct. 17, 2012

(30) Foreign Application Priority Data
Oct. 21, 2011 (JP) 2011-232152

(51) Int. Cl. G06F 17/00

(52) U.S. Cl. 715/201

(57) ABSTRACT

A viewer unit, comprising a shift sequence determination device configured to determine a shift sequence in which display ranges corresponding to the screen size of the display device are shifted sequentially within the page image of the digital comic data, the shift sequence determination device determining the shift sequence to sequentially display the display ranges including the key region on the display device based on the collateral information of the digital comic data; and a display control device configured to sequentially extract the images of each display range from the page image in accordance with the shift sequence of the display ranges determined by the shift sequence determination device and displays the images on the display device.

### BACKGROUND OF THE INVENTION

1. Field of the Invention

The present invention relates to a viewer unit, a server unit, a display control method, a digital comic editing method and a non-transitory computer-readable medium, and particularly relates to an art to display a digital comic.

2. Description of the Related Art

Recently, digital comics can be viewed even on a display unit which has a small size screen such as mobile phone.

Japanese Patent Application Laid-Open No. 2005-202062 discloses a display unit which is configured to determine whether a specified divided region of a comic (digital comic) image of a full page (for example, frame region) can be displayed on one screen. When it is determined that the entire region cannot be displayed on one screen, the display unit displays the entire specified region while dividing the region into multiple parts (i.e., multiple times on multiple screens). When displaying the specified region while dividing the region into multiple parts, there are two modes available; i.e., a mode in which the screen is fed in accordance with a screen feed operation made by a user, and a mode in which the screens are automatically fed at predetermined time intervals.

Japanese Patent Application Laid-Open No. 2004-355235 describes that plural frames may be positioned in a specific frame of a comic (digital comic).

### SUMMARY OF THE INVENTION

However, when the screen is fed every time when the screen feed operation is made by the user, there is a problem that the user is inevitably forced to view unimportant regions. That is, conventionally, the user was not permitted to sequentially view important regions of a digital comic. Depending on the size of the display screen of the display unit, frequent screen feed operations were required. Also, when the user is imposed to view unimportant portions so many times while making the screen feed operation, not only the user was made bored but also the story of the comic was hardly understood.

Even when the screens are automatically fed at predetermined time intervals, the problem that the user is forced to view unimportant parts cannot be solved, and therefore the user is inevitably made bored.

Also, it is not easy to set and input the regions while separating the regions into regions to be displayed (specified region) and regions not to be displayed (non-specified region) for each page or frame.

The present invention has been proposed in view of the above circumstances. An object of the present invention is to provide a viewer unit, a server unit, a display control method, a digital comic editing method and a non-transitory computer-readable medium allowing a user to easily understand the story while sequentially viewing key regions of a digital comic.

To achieve the object, the present invention provides a viewer unit, which includes: a data acquisition device configured to acquires a piece of digital comic data which includes a page image of each page of a comic and a piece of collateral information corresponding to each page or all pages of the comic, the collateral information including, as a piece of region information of a key region, at least one of: a piece of text region information representing a text region in which text is written within the page image; a piece of speech bubble region information representing a speech bubble region drawn with a speech bubble within the page image; and a piece of interest region information representing an interest region drawn with an interest object of the comic within the page image, a display device having a predetermined screen size; a shift sequence determination device configured to determines a shift sequence in which display ranges corresponding to the screen size of the display device are shifted sequentially within the page image of the digital comic data, the shift sequence determination device determining the shift sequence to sequentially display the display ranges including the key region on the display device based on the collateral information of the digital comic data; and a display control device configured to sequentially extracts the images of each display range from the page image in accordance with the shift sequence of the display ranges determined by the shift sequence determination device and displays the images on the display device.

In one embodiment, the shift sequence determination device determines whether any key region exists within a difference region before and after shifting of the display ranges when the display ranges are shifted within the page image, and when it is determined that no key region exists within the difference region, determines the shift sequence of the display ranges while omitting a shift corresponding to the difference region.

In one embodiment, the collateral information includes a piece of frame region information representing a region of each frame within the page image, and when the display size of each frame within the page image is larger than the screen size of the display device, the shift sequence determination device determines the shift sequence to sequentially shift the display ranges within each frame.

One embodiment further includes a mode switch instruction input device configured to receives a switch instruction input to switch between an entire region display mode in which the entire region of the page image is sequentially displayed and a key region display mode in which the key regions within the page image are sequentially displayed, wherein the shift sequence determination device determines the shift sequence, in the case of the entire region display mode, to sequentially display the entire region of the page image; and determines the shift sequence, in the case of the key region display mode, to sequentially display the display ranges including the key region based on the collateral information of the digital comic data.

In one embodiment, the collateral information includes numerical values corresponding to the degree of importance of each frame or each region, wherein the shift sequence determination device determines the shift sequence of the display ranges based on the numerical values corresponding to the degree of importance in the collateral information.

In one embodiment, the collateral information includes a piece of key region designation information which designates any one of the text region, the speech bubble region and the interest region as the key region, wherein the shift sequence determination device determines the shift sequence of the display ranges based on the key region designation information in the collateral information.

One embodiment further includes a detailed mode setting input device configured to receives detailed mode setting input which designates any one of the text region, the speech bubble region and the interest region as the key region, wherein the shift sequence determination device determines the shift sequence of the display ranges based on the detailed mode which is set and input through the detailed mode setting input device.

In one embodiment, the shift sequence determination device determines the shift sequence of the display ranges based on the screen size of the display device.

One embodiment further includes a shift instruction input device configured to receives a shift instruction input of the display ranges displayed on the display device, wherein the display control device shifts the display ranges displayed on the display device within the page image every time when the shift instruction is input through the shift instruction input device.

In one embodiment, the text region information is a piece of coordinate data representing each vertex on an external edge of a polygonal shape of the text region, a piece of vector data representing an external edge of the text region or a piece of mask data representing the text region.

In one embodiment, the speech bubble region information is a piece of vector data representing the external edge of the speech bubble region or a piece of mask data representing the speech bubble region.

In one embodiment, the interest region information is a piece of region information representing a region drawn with a character who appears on the comic as the interest region.

In one embodiment, the interest region information is a piece of coordinate data representing each vertex on the external edge of a polygonal shape of the interest region, a piece of vector data representing an external edge of the interest region or a piece of mask data representing the interest region.

Also, the present invention provides a server unit for transmitting a piece of digital comic data to a viewer unit having a predetermined screen size, the digital comic data including a page image of each page of a comic and a piece of collateral information corresponding to each page or all pages of the comic, the collateral information including, as a piece of region information of a key region, at least one of: a piece of text region information representing a text region in which text is written within the page image; a piece of speech bubble region information representing a speech bubble region drawn with a speech bubble within the page image; and a piece of interest region information representing an interest region drawn with an interest object of the comic within the page image; the server unit includes: a data acquisition device configured to acquires the digital comic data; a shift sequence determination device configured to determines a shift sequence in which displays ranges corresponding to the screen size of display device are shifted sequentially within the page image of the digital comic data, the shift sequence determination device determining the shift sequence to sequentially display the display ranges including the key region on the display device based on the collateral information of the digital comic data; and an information editing device configured to performs information editing to write a piece of shift sequence information representing the shift sequence determined by the shift sequence determination device into the collateral information of the digital comic data.

In one embodiment, the shift sequence determination device determines whether any key region exists within a difference region before and after shifting of the display ranges when the display ranges are shifted within the page image, and when it is determined that no key region exists within the difference region, determines the shift sequence of the display ranges while omitting a shift corresponding to the difference region.

In one embodiment, the collateral information includes a piece of frame region information representing a region of each frame within the page image, when the display size of each frame within the page image is larger than the screen size, the shift sequence determination device determines the shift sequence to sequentially shift the display ranges within each frame.

In one embodiment, the information editing device of the server unit writes a piece of shift sequence information for entire region display mode in which the entire region of the page image is sequentially displayed and a piece of shift sequence information for key region display mode in which key regions in the page image are sequentially displayed into the collateral information.

One embodiment provides a viewer unit including: a reception device configured to receives the digital comic data from the server unit; a display device having a predetermined screen size; and a display control device configured to sequentially extracts images of the display ranges from the page image and displays the images on the display device in accordance with the shift sequence information in the collateral information of the digital comic data received by the reception device.

One embodiment provides a viewer unit including: a reception device configured to receives the digital comic data from the server unit; display device having a predetermined screen size; a display control device configured to sequentially extracts images of the display ranges from the page image and displays the images on the display device in accordance with the shift sequence information in the collateral information of the digital comic data received by the reception device; a mode switch instruction input device configured to receives a switch instruction input to switch between the entire region display mode and the key region display mode, wherein the display control device sequentially displays the entire region of the page image on the display device in the case of the entire region display mode, and sequentially displays the display ranges including the key region on the display device based on the collateral information of the digital comic data in the case of the key region display mode.

Also, the present invention provides a display control method for displaying a digital comic on a display device having a predetermined screen size, the display control method, which includes the steps of: acquiring a piece of digital comic data which includes a page image of each page of a comic and a piece of collateral information corresponding to each page or all pages of the comic, the collateral information including, as a piece of region information of a key region, at least one of: a piece of text region information representing a text region in which text is written within the page image; a piece of speech bubble region information representing a speech bubble region drawn with a speech bubble within the page image; and a piece of interest region information representing an interest region drawn with an interest object of the comic within the page image, determining a shift sequence in which display ranges corresponding to the screen size of the display device are shifted sequentially within the page image of the digital comic data, and determining the shift sequence to sequentially display the display ranges including the key region on the display device based on the collateral information of the digital comic data; and sequentially extracting the images of each display range from the page image in accordance with the shift sequence of the display ranges determined by the shift sequence determination step to display the images on the display device.

Also, the present invention provides a digital comic editing method for editing a piece of digital comic data which includes a page image of each page of a comic and a piece of collateral information corresponding to each page or all pages of the comic, the collateral information including, as a piece of region information of a key region, at least one of: a piece of text region information representing a text region in which text is written within the page image; a piece of speech bubble region information representing a speech bubble region drawn with a speech bubble within the page image; and a piece of interest region information representing an interest region drawn with an interest object of the comic within the page image, wherein the digital comic editing method includes the steps of: acquiring the digital comic data; determining a shift sequence in which display ranges corresponding to the predetermined screen size of the display device are shifted sequentially within the page image of the digital comic data, and determining the shift sequence to sequentially display the display ranges including the key region on the display device based on the collateral information of the digital comic data; and performing information editing to write a piece of shift sequence information representing the shift sequence determined by the shift sequence determination device into the collateral information of the digital comic data.

Also, the present invention provides a non-transitory computer-readable medium storing a program (or a storage device storing the program) causing a computer unit to execute the display control method.

Also, the present invention provides a non-transitory computer-readable medium storing a program (or a storage device storing the program) causing a computer unit to execute the digital comic editing method.

The present invention allows the user to easily understand the story of the digital comic while sequentially viewing the key regions.

### BRIEF DESCRIPTION OF THE DRAWINGS

FIG. 1 illustrates the entire configuration of an example of a digital comic browsing system;

FIG. 2 illustrates an example of an information file;

FIG. 3 is a block diagram showing an example of an internal configuration of a server unit and a digital viewer unit according to a first embodiment;

FIG. 4 is a schematic flowchart showing an example of display control processing;

FIG. 5 illustrates an example of a page image;

FIG. 6 illustrates reproduction sequence of frames;

FIG. 7A illustrates speech bubble region information, FIG. 7B illustrates a text region, and FIG. 7C illustrates interest region information;

FIG. 8 illustrates a first embodiment of display control;

FIG. 9 illustrates a display example on the digital viewer unit according to the first embodiment of the display control;

FIG. 10 illustrates a second embodiment of the display control;

FIG. 11 illustrates a display example on a digital viewer unit in the second embodiment of the display control;

FIG. 12 illustrates a shift example of a display region when the text region only is the key region;

FIG. 13 illustrates a shift example of a display region when the interest region only is the key region; and

FIG. 14 is a block diagram showing an example of internal configuration of a server unit and a digital viewer unit according to a second embodiment.

### DETAILED DESCRIPTION OF THE PREFERRED EMBODIMENTS

Referring to the appended drawings, embodiments of the present invention will be described in detail bellow.

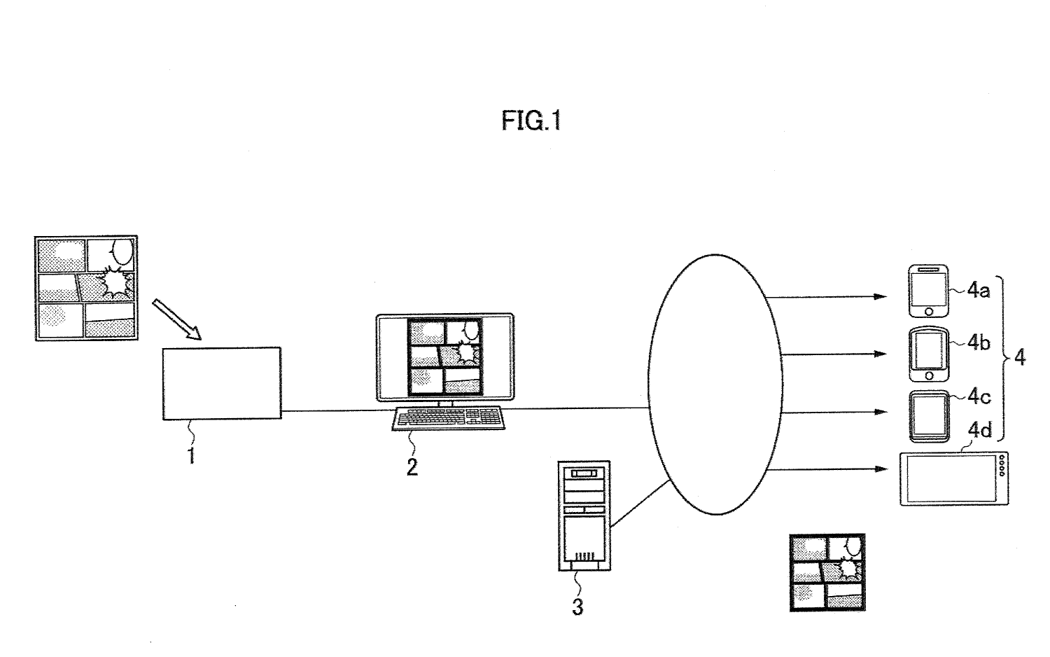

FIG. 1 illustrates the entire configuration of an example of a digital comic browsing system.

A scanner 1 reads an original of a comic (manga) on a sheet of paper to generate an image file which includes an image of each page of the comic (hereinafter, referred to as page image). FIG. 1 illustrates an example in which the image file is acquired by reading an original comic on a sheet of paper as an original which is scanned by the scanner 1, but the present invention is not limited to the above. The image file may be acquired by inputting a comic original which is electronically generated (digital original) via a network or a recording medium.

A digital comic editing unit 2 is an apparatus that edits a piece of digital comic data which includes the image file input through the scanner 1 or the like to generate a piece of master data of a digital comic. The digital comic editing unit 2 is constituted of, for example, a computer unit.

A server unit 3 converts the master data of the digital comic edited by the digital comic editing unit 2 into a piece of digital comic data of a format corresponding to each of viewer units 4 (4a-4d) as appropriate, and transmits the digital comic data via a network at the delivery request from the viewer unit 4. The server unit 3 is constituted of, for example, a computer unit.

The digital book viewer unit 4 receives the digital comic data transmitted from the server unit 3, and displays the page image (or frame image). The viewer unit 4 may be one of various types of mobile terminals such as a mobile phone, a tablet teiniinal and the like or one of various types of terminal units such a personal computer.

The display screen size of the digital book viewer unit 4 varies depending on the model thereof. When the display screen size of the digital book viewer unit 4 is smaller than the entire display size of the page image of each page of the digital comic data, the display is performed while shifting sequentially the display ranges corresponding to the display screen size of the digital book viewer unit 4 in a predetermined shift sequence within the page image of the page. To display the images sequentially on the display screen of the viewer unit 4 while shifting the display ranges corresponding to display screen size within the page image may be hereinafter referred to as “sequential reproduction” or “screen-feed reproduction”.

The digital comic data transmitted from the server unit 3 to the digital book viewer unit 4 is constituted of an image file including page image and an information file (collateral information).

The page image is a high resolution image (for example 3000×5000 pixels or 1500×2000 pixels) for each page.

The information file is a piece of information corresponding to all pages (or each page) of the comic. For example, the information file is written with a markup language such as XML file.

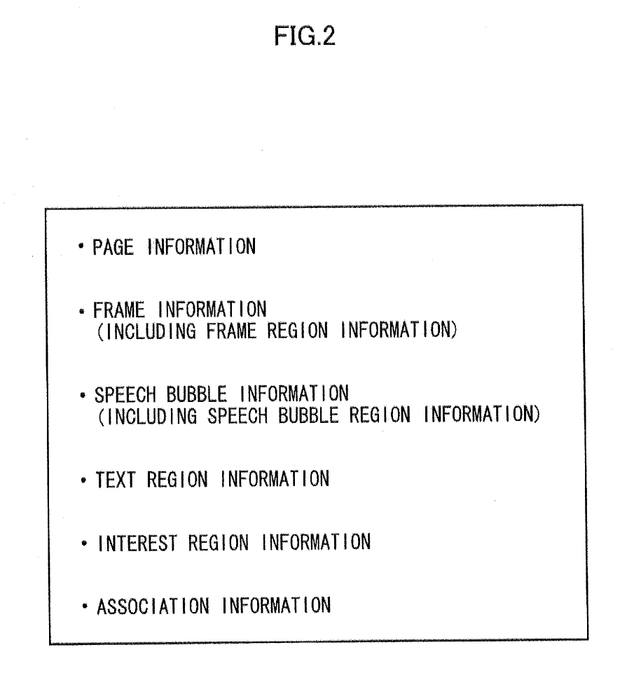

FIG. 2 shows an example of the information file.

The information file according to the embodiment includes a piece of page information relevant to a page, a piece of frame information relevant to a frame, a piece of speech bubble information relevant to a speech bubble, a piece of text region information relevant to a text region, a piece of interest region information relevant to interest region, and a piece of association information representing association among these pieces of information.

The page information includes a piece of information relevant to a page, a page name and a page ID. The information relevant to a page includes a piece of information on the content image which is provided on one-page open or two-page open, size of the original content and the like. The page information of the embodiment includes a piece of information relevant to the digital comic (title ID, title name, author, publisher (publication right holder), publication year, the language and the like).

The frame information includes a piece of frame region information. The frame region information represents a region of the frames within the page image (frame region). The frame region information of the embodiment includes coordinates of vertexes of each frame and shape of each frame. The frame region information may be a piece of vector data representing a frame boundary or a piece of mask data representing frame region. The frame information includes number of frames included in the page image and a piece of frame sequence information representing reproduction sequence of the frames within the page image. As for the reproduction sequence of the frames, a appropriate pattern is selected from some transition patterns of frame sequence such as from the upper-right toward the lower-left, from the upper-left toward lower-right, and a shift direction (horizontal direction or vertical direction) in the page based on, for example, a piece of information relevant to right-open/left-open page, a piece of information relevant to content representing language used, frame allotment detected from the frame region information and the like. The reproduction sequence of the frames is automatically determined in accordance with the selected transition pattern.

The speech bubble information includes a piece of speech bubble region information. As for the speech bubble region information, for example, a piece of vector data representing an external edge of the speech bubble region and a piece of mask data (bitmap information) representing the speech bubble region are possible. The speech bubble region information is a piece of information representing a speech bubble region in a page image (or in a frame). The speech bubble region information may include a shape of the speech bubble, a start point (vertex on the speech bubble) and a direction of the speech bubble and a size of the speech bubble. The speech bubble region information may be represented with a specific point (center point) of the speech bubble and a size of the speech bubble. The speech bubble information may further include a piece of information of text included in the speech bubble, attributes of a line of the speech bubble (dotted line, solid line etc), a piece of identification information of a speaker in the speech bubble, a frame included in the speech bubble.

The text information includes a piece of text region information and a piece of information on the content of the text. As for the text region information, for example, a piece of coordinate data (coordinate data representing vertexes on the external edge of a polygonal shape) at plural points corresponding to the text region on a line, a piece of vector data representing the external edge of the text region, a piece of mask data representing a text region (range) (for example, bitmap information) are possible. The information on the content of the text includes a piece of information on text character attributes detected by an OCR, number of lines, line spacing, character proportional spacing, a method to switch the display, the language used, vertical/horizontal writing, a reading direction and the like. The character attribute information includes a character size (point number etc), a character type (font, highlighted character etc). The text information includes a speech of a speaker in the speech bubble. The text information may also include a translated sentence and of various languages corresponding to the original speech disposed in the speech bubble, and the language used (sentences translated into two or more languages).

As for the interest region information, a piece of coordinate data representing vertexes (vertexes of the external edge of the polygonal shape) of a region of interest (referred to as “ROI”), a piece of vector data representing the external edge of the ROI, a piece of mask data (for example, bitmap data) representing the ROI and the like are possible. The interest region information may include a piece of data representing a shape of the ROI. The interest region information may further include a piece of information on the characters included in the ROI (for example, automatically added character ID). Moreover, the interest region information may include the priority, degree of importance at display, identification information of the characters (name etc), attributes of the characters (sex, age etc). The interest region information according to this embodiment represents a region where the characters appear in the comic.

The association information is a piece of information representing association among the regions in the page image. As for association information, association between the text region and the interest region, association between the speech bubble region and the interest region, association between the text region and the speech bubble region, association between the text region and the frame, association between the speech bubble region and the frame, association between the interest region and the frame and the like are possible.

In the following description, a first embodiment in which the shift sequence of the display ranges in the page image is determined by the digital book viewer unit 4; and a second embodiment in which the shift sequence of display ranges in the page image is determined by the server unit 3 will be described in detail.

### First Embodiment

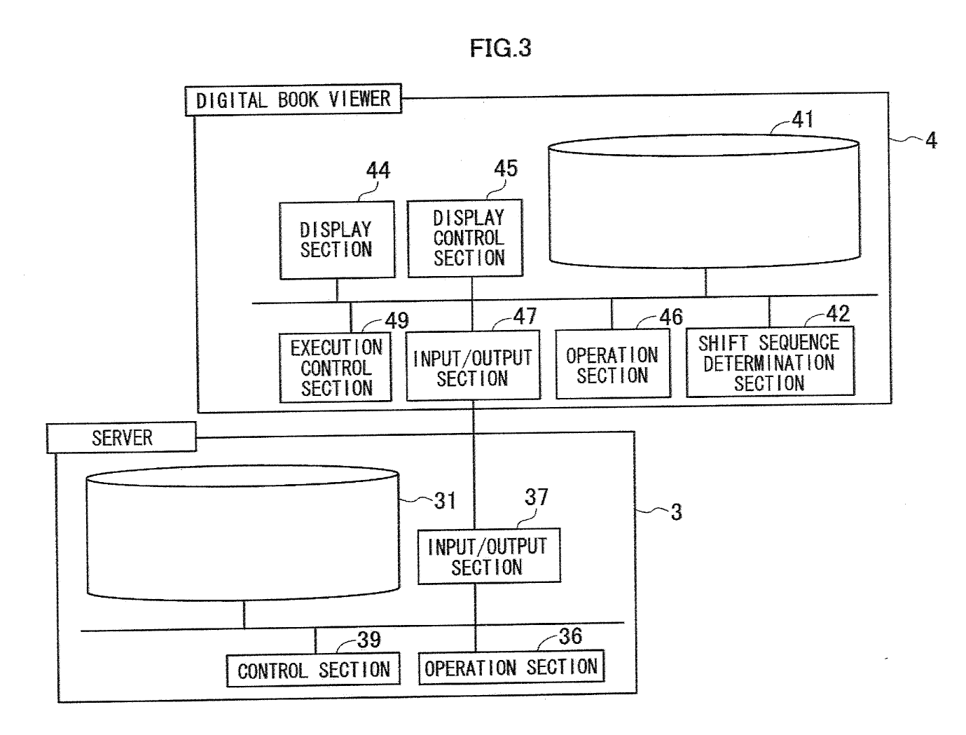

FIG. 3 illustrates an example of internal configuration of a server unit 3 and a digital book viewer unit 4 according to a first embodiment.

The server unit 3 is a computer unit which includes an operation device capable of receiving instruction input made by a specific administrator, an input/output device capable of inputting (obtaining) and outputting various kinds of information, a control device that controls and performs various kinds of arithmetic processing, and a storage device. The digital book viewer unit 4 is a terminal unit including a display device capable of displaying images, an operation device capable of receiving instruction inputs made by the user, an input/output device capable of inputting (obtaining) and outputting various kinds of information and a control device that controls and performs various kinds of arithmetic processing. The digital book viewer unit 4 is constituted of, for example, various kinds of mobile terminal such as mobile phone, mobile tablet terminal, mobile game machine and mobile computer unit. A large number of indefinite digital book viewer units 4 may access the server unit 3.

Referring to FIG. 3, the server unit 3 includes a database (DB) 31, an operation section 36, an input/output section 37 and control section 39.

The DB 31 is constituted of a storage device such as hard disk and memory. The DB 31 stores the digital comic data. The operation section 36 is constituted of an operation device such as a keyboard, a mouse and a touch pad. The input/output section 37 is constituted of a communication device according to the embodiment. The control section 39 is constituted of a control device such as CPU (Central Processing Unit).

Referring to FIG. 3, the digital book viewer unit 4 includes a database (DB) 41, a shift sequence determination section 42, a display section 44, a display control section 45, an operation section 46, an input/output section 47 and an execution control section 49.

The DB 41 stores various kinds of information such as digital comic data. The digital comic data according to the embodiment is, as described above, constituted of an image file including a page image of each page of the comic and an information file (collateral information) corresponding to each page (or all pages) of the comic. The information file according to the embodiment includes a piece of text region information indicating a text region in which text is written in the page image, a piece of speech bubble region information representing a speech bubble region drawn with speech bubbles in the page image, and a piece of interest region information representing an interest region drawn with interest objects of the comic in the page image. Various kinds of modes are available for selecting the key region from the text region, the speech bubble region and the interest region. The description thereof will be made later.

The shift sequence determination section 42 determines a shift sequence (shift sequence for screen feeding) for shifting sequentially the display ranges in the page image of the digital comic data.

The display section 44 is display device which is constituted of a display device capable of displaying images, and which has a predetermined screen size. The display section 44 is constituted of, for example, an LCD.

The display control section 45 (display control device) displays images of the display ranges in the page image sequentially on the display section 44 in accordance with the shift sequence determined by the shift sequence determination section 42.

The operation section 46 receives an instruction input made by the user. The operation section 46 may be a touch sensor, a key-input device or a pointing device disposed on the screen of the display section 44.

The operation section 46 according to the embodiment functions firstly as a mode switch instruction input device configured to receives switch instruction input to switch the mode between an entire region display mode in which the entire region of the page image is displayed sequentially and a key region display mode in which key regions in the page image is displayed sequentially.

Secondly, the operation section 46 according to the embodiment, functions as shift instruction input device configured to receives an input of shift instruction (screen feed instruction) of the display ranges displayed on the display section 44.

The input/output section 47 inputs and outputs various kinds of information. The input/output section 47 according to the embodiment is constituted of a communication device that communicates with the server unit 3. The input/output section 47 transmits a digital comic data request to the server unit 3, and receives a piece of digital comic data from the server unit 3; to thereby acquire the digital comic data. The input/output section 47 is not particularly limited to the communication device such as in the embodiment, but may be an input/output device which writes on and reads from a computer readable recording medium.

Subsequently, the shift sequence determination section 42 will be described below in detail.

The shift sequence determination section 42 determines the shift sequence (screen feed shift sequence) to sequentially shift the display ranges in the page image of the digital comic data. The size of the display ranges matches with the screen size of the display section 44. The shift sequence determination section 42 according to the embodiment determines the shift sequence to sequentially display the display ranges including the key region on the display section 44 based on the information file of the digital comic data. Here, a piece of basic sequence information which does not depend on the model of the digital book viewer unit 4 may be previously written in the information file of the digital comic data. The present invention is applicable even when no basic sequence information is previously written in the information file of the digital comic data.

After shifting the display range within the page image, the shift sequence determination section 42 according to the embodiment determines whether any key region exists within a difference region before and after shifting the display range. When it is determined that no key region exists in the difference region, the shift sequence of the display ranges is determined while omitting the shift corresponding to the difference region.

The information file (collateral information) includes the frame region information representing frame regions in the page image. When the display size of each frame in the page image is larger than the screen size of the display section 44, the shift sequence determination section 42 according to the embodiment determines the shift sequence to sequentially shift the display ranges in each frame.

In the entire region display mode, the shift sequence determination section 42 of the embodiment determines the shift sequence to display the entire region of page image sequentially; and when in the key region display mode, the shift sequence determination section 42 determines the shift sequence to sequentially display the display ranges including a key region based on the information file of the digital comic data.

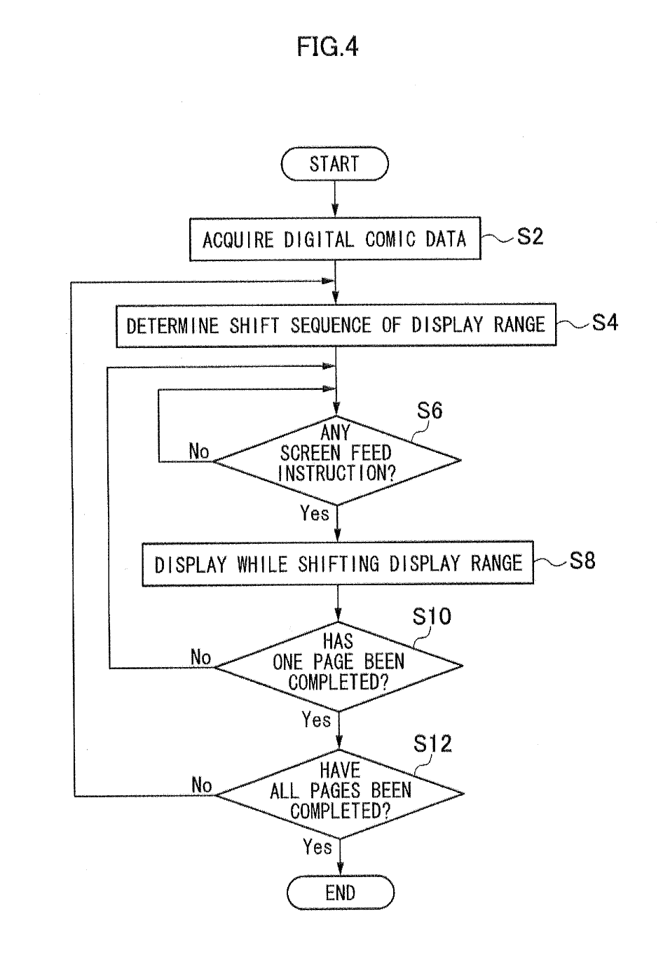

FIG. 4 is a flowchart roughly showing an example of a display control processing flow in the digital book viewer unit 4 according to the first embodiment shown in FIG. 3. The processing is executed in accordance with a program under an integrated control by execution control section 49 of the digital book viewer unit 4. The program may be provided being recorded in a predetermined recording medium, or may be provided via a network.

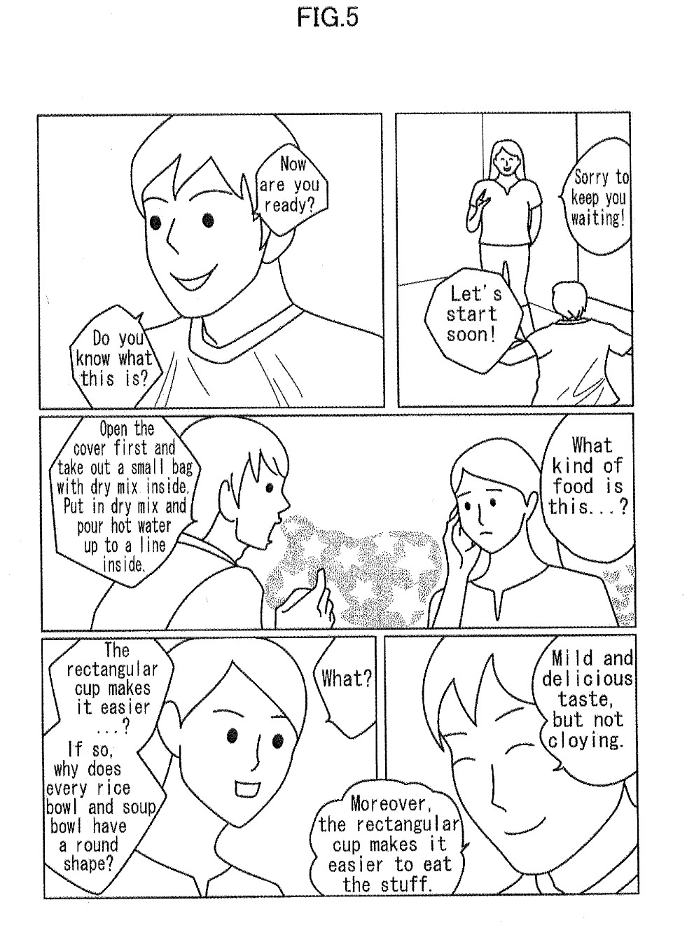

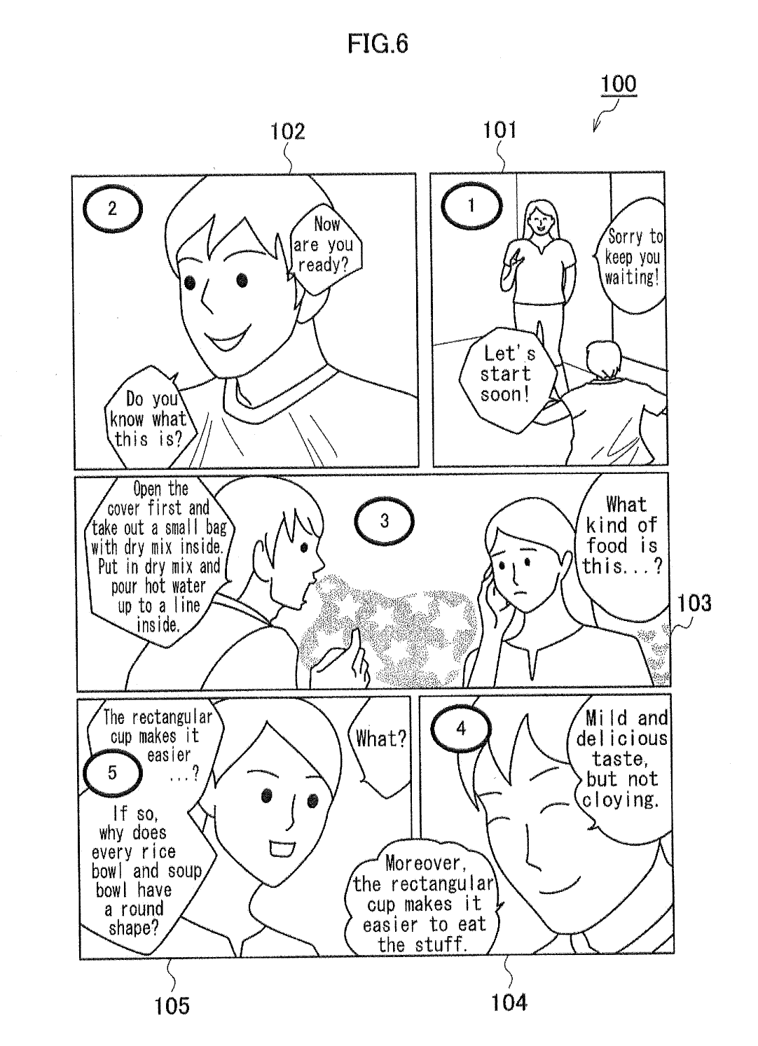

First of all the digital book viewer unit 4 acquires a piece of digital comic data from the server unit 3 through the input/output section 47 (data acquisition device) (step S2). When the digital comic data is previously stored in the DB 41 of the digital book viewer unit 4, the following processing may be performed by using the digital comic data in the DB 41. The following description will be made assuming that a piece of digital comic data including a page image shown in FIG. 5 has been acquired. The page image shown in FIG. 5 has five frames and in the frame information of the information file of the digital comic data, a reproduction sequence of the five frames is described as shown in FIG. 6. In FIG. 6, the frame reproduction sequence of the page image 100 is: a frame with reference numeral 101, a frame with reference numeral 102, a frame with reference numeral 103, a frame with reference numeral 104, and a frame with reference numeral 105 sequentially. According to the embodiment, the information file of the digital comic data is described with a reproduction sequence of each frame. Even when the information file is not described with reproduction sequence of the frames, the reproduction sequence of the frames can be determined based on a piece of information on two-page spread written in the page information or a piece of information on the language.

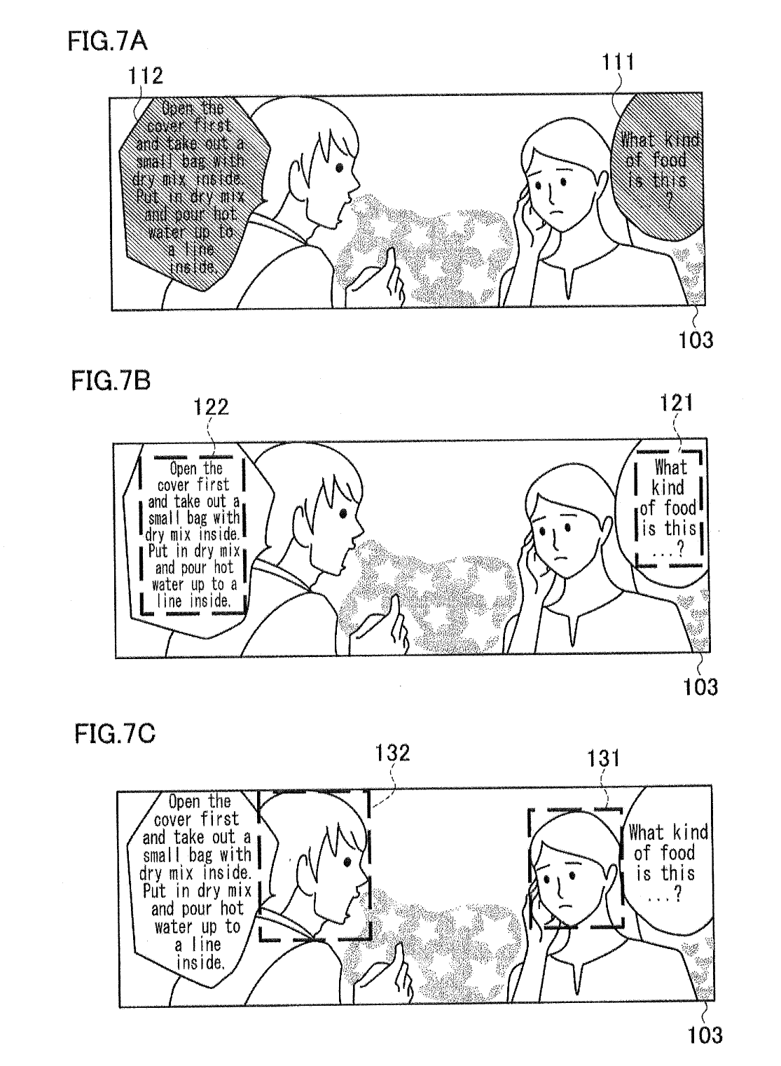

It is assumed that the information file of the digital comic data according to the embodiment has described therein a piece of speech bubble region information, a piece of text region information and a piece of interest region information. For example, in the case of the third frame 103 shown in FIG. 6, region information (speech bubble region information) of the speech bubble regions 111, 112 indicated with hatched lines as shown in FIG. 7A; region information (text region information) of the text regions 121, 122 indicated with dotted lines as shown in FIG. 7B; and region information (interest region information) of the interest regions 131, 132 indicated with dotted lines as shown in FIG. 7C are described in the information file. The interest region according to the embodiment is a region drawn with a character appearing on the comic (for example, comic character).

Subsequently, the shift sequence determination section 42 determines the shift sequence to sequentially shift display ranges corresponding to the screen size of the display section 44 within the page image of the digital comic data (step S4). The shift sequence determination section 42 determines the shift sequence to sequentially display the display ranges including the key region within the page image on the display section 44 based on the information file of the digital comic data. Various kinds of modes are available for determining the shift sequence of the display ranges. Description on the determination modes will be given later.

Subsequently, it is determine whether a shift instruction (referred to as “screen feed instruction”) of the display ranges is input through the operation section 46 (step S6). Every time when a screen feed instruction is input through the operation section 46, the display control section 25 shifts the display ranges within the page image in accordance with the shift sequence of the display ranges determined in the step S4, and extracts the images for each display range from the page image to display the images within the display range on the display section 44 (step S8).

Subsequently, it is determined whether the one page has been completed (step S10). If not, the process returns to step S6. If completed, it is determined whether all pages have been complete (step S12). If not, the process returns to step S4. If completed, the processing is terminated.

Some methods are available to recognize a region in the page image as the key region. Here, a description will be made on an embodiment in which a speech bubble region and interest region are recognized as a key region to determine the shift sequence (first embodiment); and an embodiment in which a text region and an interest region are recognized as a key region to determine the shift sequence (second embodiment).

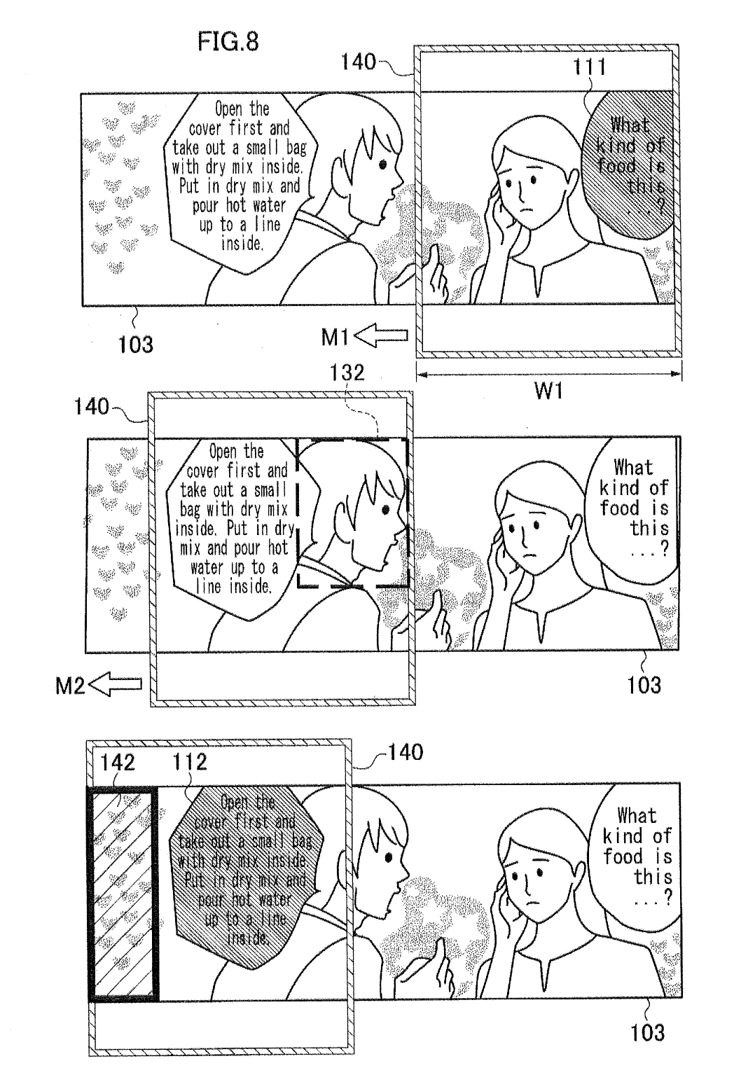

FIG. 8 illustrates a first embodiment, in which the display frame 140 (display range in the page image 100 displayed on the display section 44) is shifted focusing on a third frame 103 in the page image 100 shown in FIG. 6.

According to the embodiment, as shown on the top in FIG. 8, the right side of the display frame 140 is aligned with the right side of the third frame 103 first. The shift sequence determination section 42 may determine an initial position of the display frame 140 (display range) based on the speech bubble region information and the interest region information of the information file; or the display position of the display frame 140 may be simply determined with reference to the right side of the frame 103. A speech bubble region 111, which is a one of the key region according to the embodiment, exists adjacent to the right side of the third frame 103. The shift sequence determination section 42 determines that a key region exists within the display frame 140, and determines the position of the display frame 140 as the first display position in the third frame 103.

In this embodiment, the display frame 140 is shifted by a size W1 of the display frame 140 (a shift amount of the display section 44 corresponding to the screen size) as the first shift M1. The shift sequence determination section 42 may determine the shift amount based on the speech bubble region information and the interest region information of the information file or determine the shift amount simply based on the screen size of the display section 44. An interest region 132, which is one of the key regions according to the embodiment, exists adjacent to the position which is shifted by the size W1 from the right side of the third frame 103. The shift sequence determination section 42 determines that a key region exists within the display frame 140, and determines the position of the display frame 140 as the second display position in the third frame 103.

Here, it is assumed, as the second shift M2, that the display frame 140 is shifted until the left side of the display frame 140 reaches the left side of the third frame 103 as shown at the bottom in FIG. 8. Neither speech bubble region nor interest regions, which are key regions according to the embodiment, exists within the difference region 142 before and after the second shift M2. When the shift sequence determination section 42 determines that no key region exists within the difference region 142 as described above, the shift M2 corresponding to the difference region 142 is omitted; and the shift sequence of the display frame 140 (display range) is determined. When it is determined that a key region exists within the difference region 142, the shift sequence of the display frame 140 (display range) is determined without omitting the shift.

Since the digital book viewer unit 4 can determine simply the shift sequence, the shift amount of the display frame 140 is preferably fixed in accordance with the screen size of the display section 44. Since the user can control the shift amount so as to easily view the interest region and the text region, the shift amount of the display frame 140 is preferably determined as a variable amount based on the speech bubble region information and the interest region information of the information file. Either mode may be selected based on the processing performance and the screen size of the digital book viewer unit 4.

The description is made above using the third frame 103 only. On other frames (101, 102, 104 and 105 in FIG. 6), the shift sequence of the display range may be determined in the same manner.

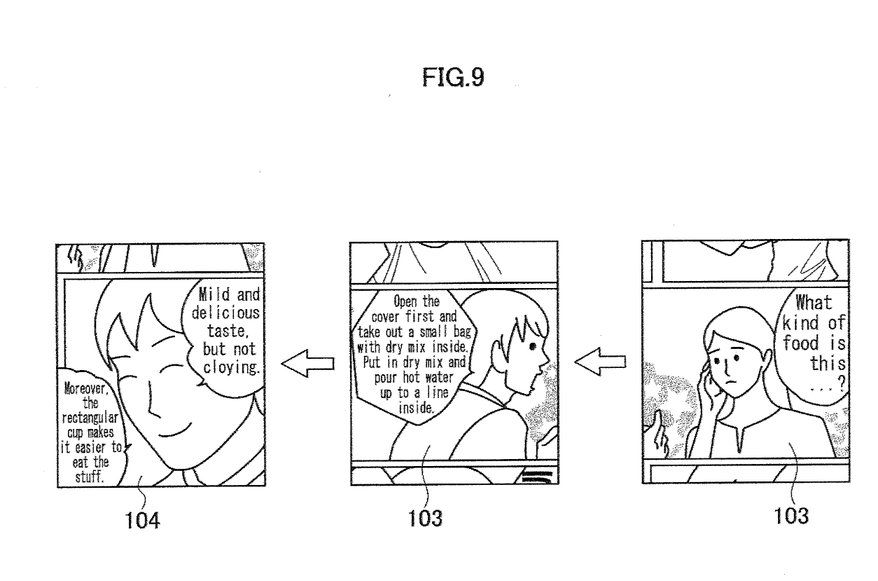

In the first embodiment, after the third frame 103 is displayed twice, third display of the third frame 103 is omitted and a fourth frame 104 is displayed as shown in FIG. 9. That is, the second shift M2 shown in FIG. 8 is omitted.

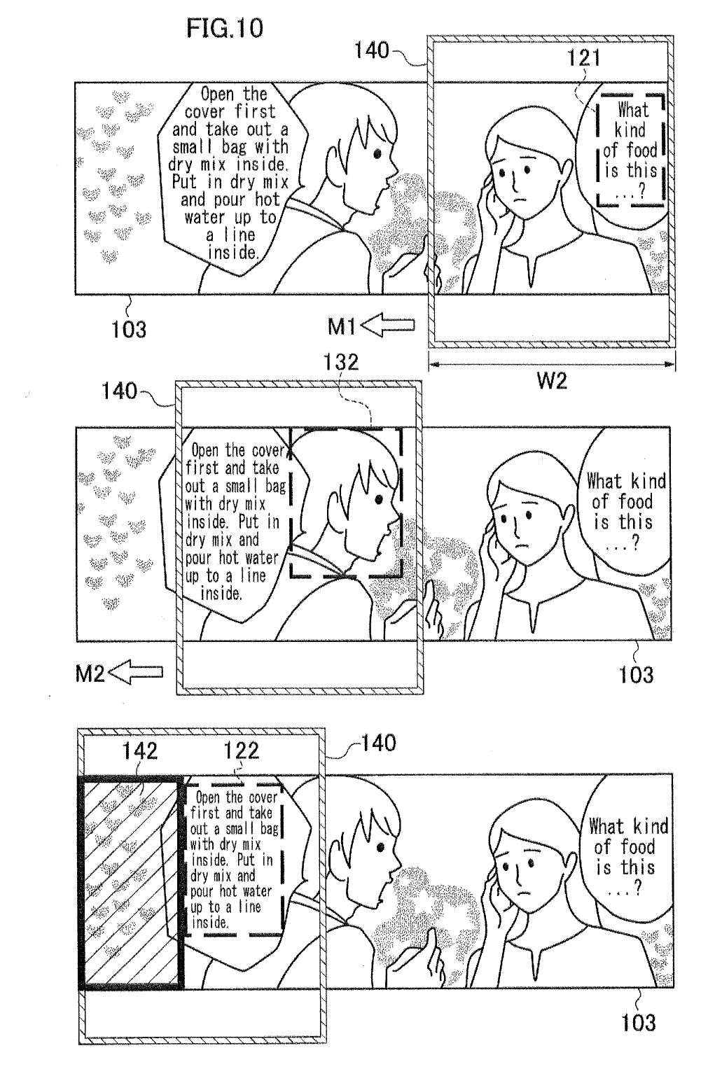

FIG. 10 illustrates the second embodiment. Focusing on the third frame 103 in the page image 100 shown in FIG. 6, the display frame 140 (in the page image 100, a display range which is displayed on the display section 44) is shifted.

In this embodiment, first of all, the right side of the display frame 140 is aligned with the right side of the third frame 103 as shown at the top in FIG. 10. The shift sequence determination section 42 may determine the initial position of the display frame 140 (display range) based on the text region information and the interest region information of the information file, or the display position of the display frame 140 may be simply determined with reference to the right side of the frame 103. A text region 121, which is one of the key regions according to the embodiment, exists adjacent to the right side of the third frame 103. The shift sequence determination section 42 determines that a key region exists within the display frame 140, and determines the position of the display frame 140 as the first display position in the third frame 103.

In this embodiment, as the first shift M1, the display frame 140 is shifted by the size W2 of the display frame 140 (a shift amount corresponding to the screen size of the display section 44). The shift sequence determination section 42 may determine the shift amount based on the text region information and the interest region information of the information file or the shift amount may be determined simply based on the screen size of the display section 44. Adjacent to the position where the display frame 140 is shifted by the size W2 from the right side of the third frame 103, the interest region 132, which is one of the key regions in the embodiment, exists. The shift sequence determination section 42 determines that a key region exists within the display frame 140, and determines the position of the display frame 140 as the second display position in the third frame 103.

The shift amount W2 of the first shift M1 is smaller the shift amount W1 in the first embodiment shown in FIG. 8. This is why the screen size of the display section 44 in the second embodiment is smaller than the case of the first embodiment.

Here, it is assumed that, as the second shift M2, the display frame 140 is shifted until the left side of the display frame 140 reaches the left side of the frame 103 as shown at the bottom in FIG. 10. In this case, neither text region nor interest regions, which are the key region in this embodiment, exists within the difference region 142 before and after the second shift M2. Thus, when it is determined that no key region exists within the difference region 142, the shift sequence determination section 42 omits the shift M2 corresponding to the difference region 142, and determines the shift sequence of the display frame 140 (display range). When it is determined that a key region exists within the difference region 142, the display frame 140 (display range) is determined as the shift sequence without omitting the shift.

Although a part of the speech bubble region exists within the difference region 142 in the second shift M2 as shown in FIG. 10, in the second embodiment, since the text region and the interest region are the key regions but the speech bubble region is not the key region, the second shift M2 is omitted.

The above description is made by using only the third frame 103. The shift sequence of the display ranges can be determined by using other frames (101, 102, 104 and 105 in FIG. 6) in the same manner.

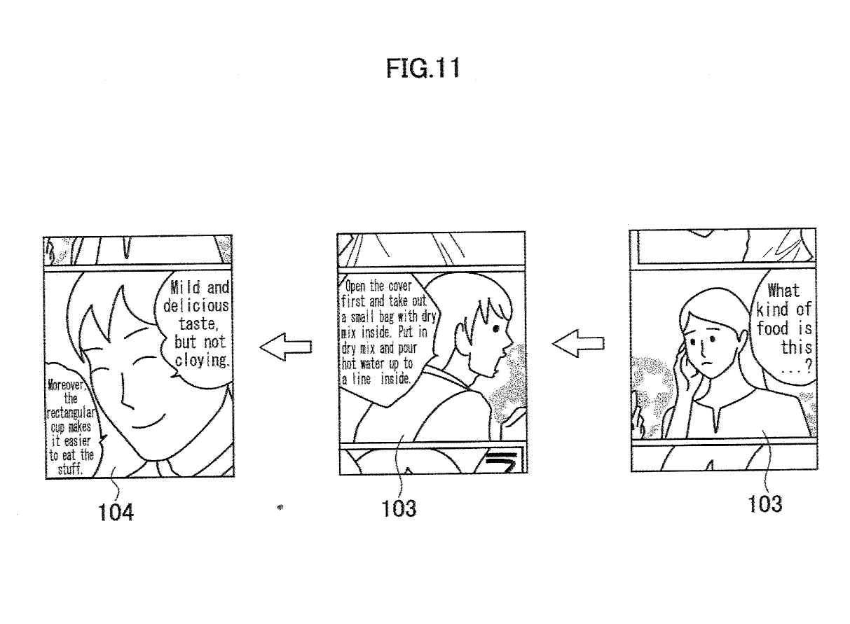

In the second embodiment, after the third frame 103 is displayed twice, the third display of the third frame 103 is omitted and the fourth frame 104 is displayed as shown in FIG. 11. That is, the second shift M2 shown in FIG. 10 is omitted.

<Type of Key Region>

As the key region, the speech bubble region, the text region and the interest region may be combined into 7 options (key region 1)-(key region 7) as described below.

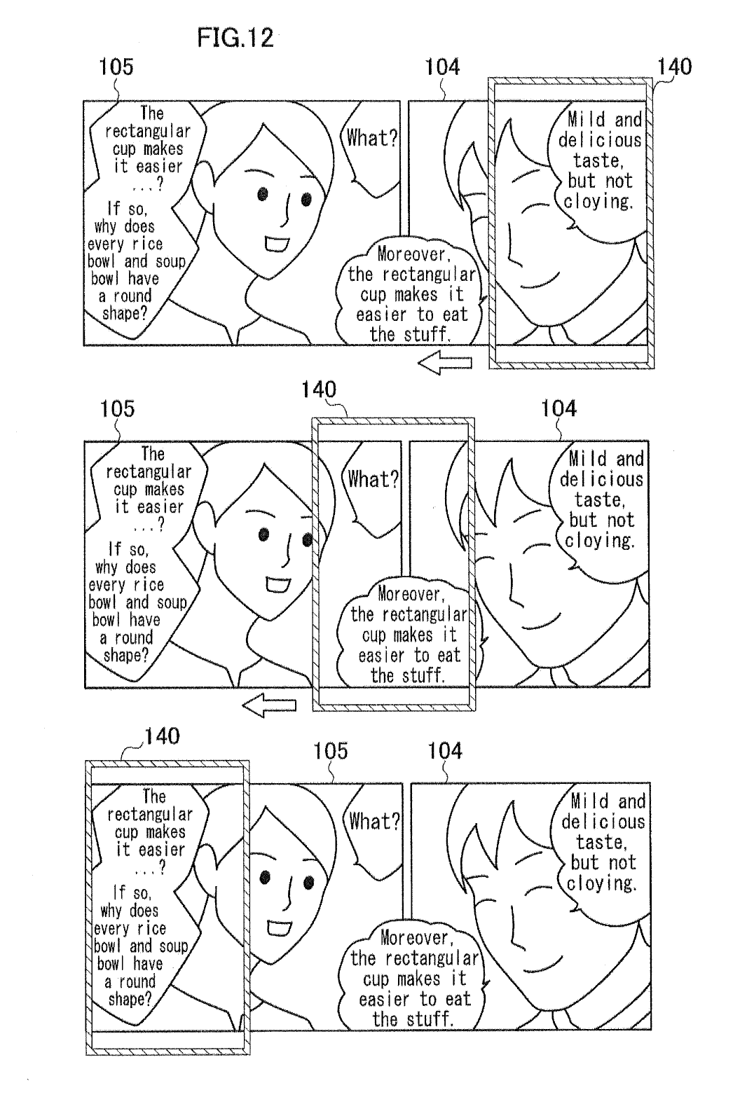

(Key region 1) The text region only is used as the key region. In this case, the shift sequence determination section 42 determines a shift sequence in which only the display ranges that include text region is displayed sequentially on the display section 44. FIG. 12 illustrates a shift example of the display frame 140 (display range) when the text region only is used as the key region. FIG. 12 illustrates only the text regions which are enclosed by a speech bubble region respectively. However, when a text region exists out of the speech bubble, the text region existing out of the speech bubble is also displayed on the display section 44.

(Key region 2) The speech bubble region only is used as the key region. In this case, the shift sequence determination section 42 determines a shift sequence in which only the display ranges that include speech bubble region are displayed sequentially on the display section 44.

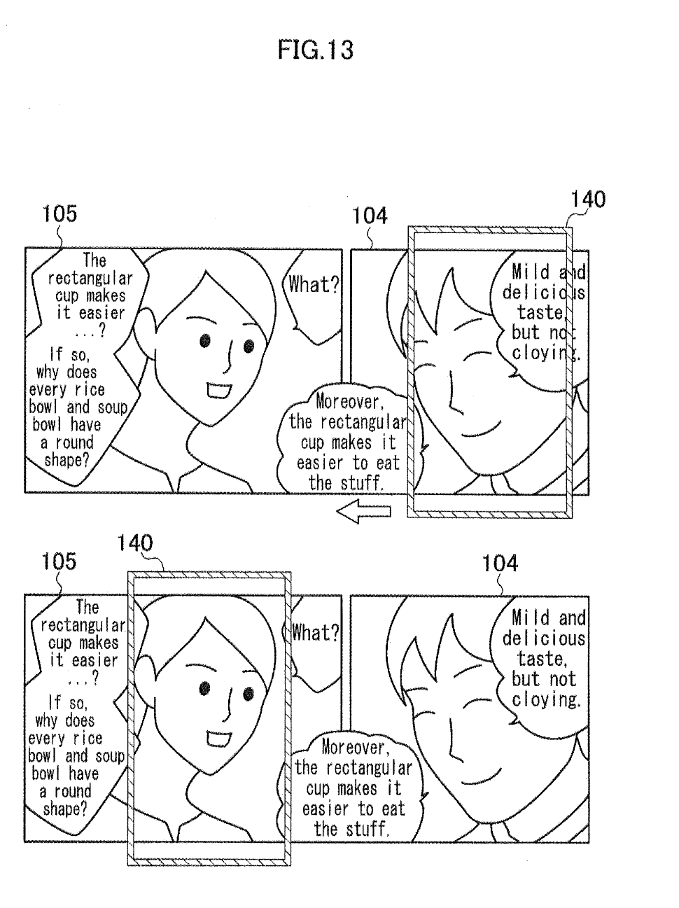

(Key region 3) The interest region only is used as the key region. In this case, the shift sequence determination section 42 determines a shift sequence in which only the display ranges that include interest region are sequentially displayed on the display section 44. FIG. 13 illustrates a shift example of the display frame 140 (display ranges) when only the interest regions are used as the key regions. In this example, the interest region information represents that face regions of the characters appearing on the comic are the interest regions. The position of the display frame 140 is determined based on the interest region information.

(Key region 4) The speech bubble region and the interest region are used as the key regions (first embodiment). In this case, the shift sequence determination section 42 determines a shift sequence in which only the display ranges that include at least one of the speech bubble region and the interest region is sequentially displayed on the display section 44.

(Key region 5) The text region and the interest region are used as the key regions (second embodiment). In this case, the shift sequence determination section 42 determines a shift sequence in which only the display ranges that include at least one of the text region and the interest region are sequentially displayed on the display section 44.

(Key region 6) The speech bubble region and the text region are used as the key regions. In this case, the shift sequence determination section 42 determines a shift sequence in which only the display ranges that include at least one of the speech bubble region and the text region are sequentially displayed on the display section 44.

(Key region 7) All of the speech bubble region, the text region and the interest region are used as the key regions. In this case, the shift sequence determination section 42 determines a shift sequence in which only the display ranges that include at least one of the speech bubble region, the text region and the interest region are sequentially displayed on the display section 44.

As described above, seven different combinations of the key regions are available. However, another case may be employed. That is, a region other than the speech bubble region, the text region and the interest region may be added as the key region. For example, such a variation that a region which includes a high frequency element may be added as a key region is possible.

<Key Region Selection>

A description is made on various kinds of mode of key region selection. The key regions may be previously determined. However, the key regions may be selected as described below (selection mode 1)-(selection mode 4).

(Selection mode 1) The information file of the digital comic data (collateral information) includes numerical values corresponding to the degree of importance for each frame or region. The shift sequence determination section 42 determines a shift sequence of the display ranges based on the numerical values corresponding to the degree of importance in the information file. For example, a value of importance (0-3) is allotted to each frame. A frame which has a value of importance of “3” is determined that the entire range is important, and the entire range should be displayed without being omitted. A frame which has a value of importance of “2” is determined that the text region and the interest region are the key regions. A frame which has a value of importance of “1” is determined that only the text region is the key region. Also, for example, each region in the frame is previously allotted with a value of importance. When a specific text region has “3” as the value of importance, the specific text region is determined as the key region. When the value of importance is “0”, the specific text region is not determined as the key region.

(Selection mode 2) The information file of the digital comic data (collateral information) includes a piece of key region designation information representing the key region from the text region, the speech bubble region and the interest object region. The shift sequence determination section 42 determines a shift sequence of the display ranges based on the key region designation information in the information file. Identical region (for example, only the text region) may be designated to every frame in all pages as the key regions. Or, different kind of region may be designated to each page or frame as the key region. For example, a specific frame is designated with only the text region as the key region; other frames are designated with the text region and the interest region as the key regions.

(Selection mode 3) The operation section 46 receives a setting input of detailed mode representing the key region from the text region, the speech bubble region and the interest object region. The shift sequence determination section 42 determines a shift sequence of the display ranges based on the set detailed mode input by the operation section 46. For example, at a first mode, only the text regions are sequentially displayed as the key regions. At a second mode, only the interest regions are sequentially displayed as the key regions. At a third mode, both of the text regions and the interest regions are sequentially displayed as the key regions.

(Selection mode 4) The shift sequence determination section 42 determines a shift sequence of the display ranges based on the screen size of the display section 44. For example, when the screen size is smaller than a threshold value, a shift sequence in which only the text regions are determined as the key regions is determined. When the screen size is larger than the threshold value, a shift sequence in which both of the text region and the speech bubble region are determined as the key regions is determined.

### Second Embodiment

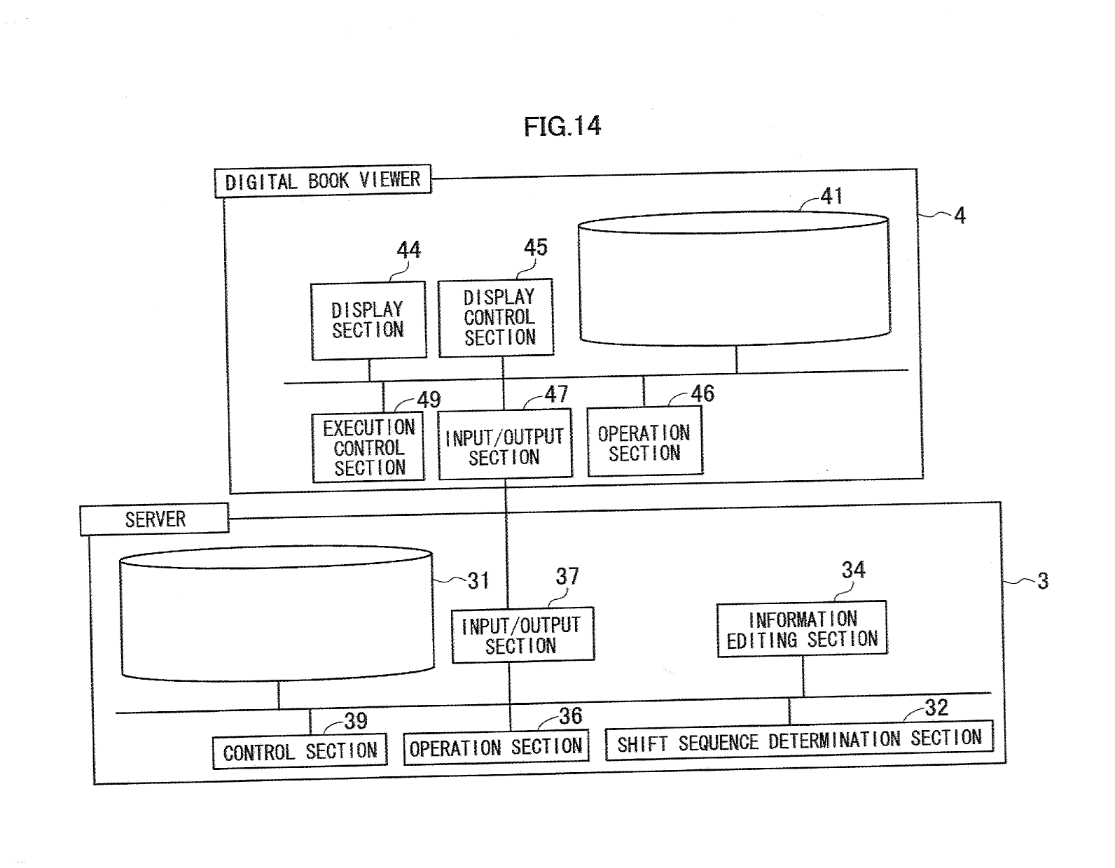

FIG. 14 illustrates an example of internal configuration of the server unit 3 and the digital book viewer unit 4 according to the second embodiment. Elements identical to those in the first embodiment shown in FIG. 3 are given with the same numerals and description thereof is omitted. According to the second embodiment, the server unit 3 determines the shift sequence of the display ranges and generates a piece of shift sequence information. The digital book viewer unit 4 performs screen feed control (shift of display ranges) based on the shift sequence information received from the server unit 3.

Referring to FIG. 14, the server unit 3 includes a shift sequence determination section 32 and an information editing section 34. Other elements (DB 31, operation section 36, input/output section 37 and control section 39) are the identical to those in the first embodiment.

The shift sequence determination section 32 of the server unit 3 in the second embodiment is an element corresponding to the shift sequence determination section 42 of the digital book viewer unit 4 in the first embodiment. That is, the shift sequence determination section 32 determines the shift sequence to sequentially shift the display ranges corresponding to the screen size (screen size of the display section 44) of the digital book viewer unit 4 within the page image of the digital comic data. In particular, the shift sequence determination section 32 determines the shift sequence to sequentially display the display ranges including a key region on the display section 44 of the digital book viewer unit 4 based on the information file of the digital comic data (collateral information).

Detailed method to determine the shift sequence is the identical to the method to determine the shift sequence in the shift sequence determination section 42 of the digital book viewer unit 4 of the first embodiment, therefore the description thereof is omitted here.

The information editing section 34 writes a piece of shift sequence information representing the shift sequence determined by the shift sequence determination section 42 into the information file of the digital comic data (collateral information). The digital comic data including the information file added with the shift sequence information by the information editing section 34 is transmitted to the digital book viewer unit 4 by the input/output section 37.

The information editing section 34 of the embodiment writes a piece of shift sequence information for the entire region display mode to sequentially display the entire regions of the page image and the shift sequence information for the key region display mode to sequentially display the key region in the page image into the information file of the digital comic data (collateral information).

The DB 41, the display section 44, the display control section 45, the operation section 46, the input/output section 47 and the execution control section 49 in the digital book viewer unit 4 have been described in the first embodiment. Therefore, the description thereof is made on different points only.

The input/output section 47 of the digital book viewer unit 4 receives the digital comic data added with the shift sequence information from the server unit 3.

The display control section 45 of the digital book viewer unit 4 sequentially extracts the images for each display range from the page image in accordance with the shift sequence information in the received information file of the digital comic data and sequentially displays the images on the display section 44; thereby the key region in the page image is sequentially displayed on the display section 44.

The operation section 46 of the digital book viewer unit 4 receives a switch instruction input to switch between the entire region display mode and the key region display mode same as the first embodiment. In the case of entire region display mode, the display control section 45 of the embodiment sequentially displays the entire region of the page image on the display section 44 in accordance with the shift sequence information for the entire region display mode in the information file. In the case of the key region display mode, the display ranges including the key region are sequentially displayed on the display section 44 in accordance with the shift sequence information for the key region display mode in the information file.

The present invention is not limited to the examples described in this specification and the examples illustrated in the drawings. Needless to say, various kinds of design changes or modifications may be possible within a range within the spirit of the present invention.

What is claimed is:

1. A viewer unit, comprising:
a data acquisition device configured to acquire a piece of digital comic data which includes a page image of each page of a comic and a piece of collateral information corresponding to each page or all pages of the comic,
the collateral information including, as a piece of region information of a key region, at least one of:
a piece of text region information representing a text region in which text is written within the page image;
a piece of speech bubble region information representing a speech bubble region drawn with a speech bubble within the page image; and
a piece of interest region information representing an interest region drawn with an interest object of the comic within the page image,
a display device having a predetermined screen size;
a shift sequence determination device configured to determine a shift sequence in which display ranges corresponding to the screen size of the display device are shifted sequentially within the page image of the digital comic data, the shift sequence determination device determining the shift sequence to sequentially display the display ranges including the key region on the display device based on the collateral information of the digital comic data; and
a display control device configured to sequentially extract the images of each display range from the page image in accordance with the shift sequence of the display ranges determined by the shift sequence determination device and displays the images on the display device.

2. The viewer unit according to claim 1, wherein the shift sequence determination device determines whether any key region exists within a difference region before and after shifting of the display ranges when the display ranges are shifted within the page image, and when it is determined that no key region exists within the difference region, determines the shift sequence of the display ranges while omitting a shift corresponding to the difference region.

3. The viewer unit according to claim 1, wherein the collateral information includes a piece of frame region information representing a region of each frame within the page image,
when the display size of each frame within the page image is larger than the screen size of the display device, the shift sequence determination device determines the shift sequence to sequentially shift the display ranges within each frame.

4. The viewer unit according to claim 1, further comprising a mode switch instruction input device configured to receive a switch instruction input to switch between an entire region display mode in which the entire region of the page image is sequentially displayed and a key region display mode in which the key regions within the page image are sequentially displayed, wherein
the shift sequence determination device determines the shift sequence, in the case of the entire region display mode, to sequentially display the entire region of the page image; and determines the shift sequence, in the case of the key region display mode, to sequentially display the display ranges including the key region based on the collateral information of the digital comic data.

5. The viewer unit according to claim 1, wherein the collateral information includes numerical values corresponding to the degree of importance of each frame or each region, wherein
the shift sequence determination device determines the shift sequence of the display ranges based on the numerical values corresponding to the degree of importance in the collateral information.

6. The viewer unit according to claim 1, wherein the collateral information includes a piece of key region designation information which designates any one of the text region, the speech bubble region and the interest region as the key region, wherein
the shift sequence determination device determines the shift sequence of the display ranges based on the key region designation information in the collateral information.

7. The viewer unit according to claim 1, further comprising a detailed mode setting input device configured to receive detailed mode setting input which designates any one of the text region, the speech bubble region and the interest region as the key region, wherein
the shift sequence determination device determines the shift sequence of the display ranges based on the detailed mode which is set and input through the detailed mode setting input device.

8. The viewer unit according to claim 1, wherein the shift sequence determination device determines the shift sequence of the display ranges based on the screen size of the display device.

9. The viewer unit according to claim 1, further comprising a shift instruction input device configured to receive a shift instruction input of the display ranges displayed on the display device, wherein
the display control device shifts the display ranges displayed on the display device within the page image every time when the shift instruction is input through the shift instruction input device.

10. The viewer unit according to claim 1, wherein the text region information is a piece of coordinate data representing each vertex on an external edge of a polygonal shape of the text region, a piece of vector data representing an external edge of the text region or a piece of mask data representing the text region.

11. The viewer unit according to claim 1, wherein the speech bubble region information is a piece of vector data representing the external edge of the speech bubble region or a piece of mask data representing the speech bubble region.

12. The viewer unit according to claim 1, wherein the interest region information is a piece of region information representing a region drawn with a character who appears on the comic as the interest region.

13. The viewer unit according to claim 1, wherein the interest region information is a piece of coordinate data representing each vertex on the external edge of a polygonal shape of the interest region, a piece of vector data representing an external edge of the interest region or a piece of mask data representing the interest region.

14. A server unit for transmitting a piece of digital comic data to a viewer unit having a predetermined screen size, the digital comic data including a page image of each page of a comic and a piece of collateral information corresponding to each page or all pages of the comic, the collateral information including, as a piece of region information of a key region, at least one of:
a piece of text region information representing a text region in which text is written within the page image;
a piece of speech bubble region information representing a speech bubble region drawn with a speech bubble within the page image; and
a piece of interest region information representing an interest region drawn with an interest object of the comic within the page image;
the server unit, comprising:
a data acquisition device configured to acquire the digital comic data;
a shift sequence determination device configured to determines a shift sequence in which display ranges corresponding to the screen size of display device are shifted sequentially within the page image of the digital comic data, the shift sequence determination device determining the shift sequence to sequentially display the display ranges including the key region on the display device based on the collateral information of the digital comic data; and
an information editing device configured to performs information editing to write a piece of shift sequence information representing the shift sequence determined by the shift sequence determination device into the collateral information of the digital comic data.

15. The server unit according to claim 14, wherein the shift sequence determination device determines whether any key region exists within a difference region before and after shifting of the display ranges when the display ranges are shifted within the page image, and when it is determined that no key region exists within the difference region, determines the shift sequence of the display ranges while omitting a shift corresponding to the difference region.

16. The server unit according to claim 14, wherein the collateral information includes a piece of frame region information representing a region of each frame within the page image, and
when the display size of each frame within the page image is larger than the screen size, the shift sequence determination device determines the shift sequence to sequentially shift the display ranges within each frame.

17. The server unit according to claim 14, wherein the information editing device of the server unit writes a piece of shift sequence information for entire region display mode in which the entire region of the page image is sequentially displayed and a piece of shift sequence information for key region display mode in which key regions in the page image are sequentially displayed into the collateral information.

18. A viewer unit comprising:
a reception device configured to receives the digital comic data from the server unit set forth in claim 14;
a display device having a predetermined screen size; and
a display control device configured to sequentially extracts images of the display ranges from the page image and displays the images on the display device in accordance with the shift sequence information in the collateral information of the digital comic data received by the reception device.

19. A viewer unit, comprising:
a reception device configured to receives the digital comic data from the server unit set forth in claim 17;
a display device having a predetermined screen size;
a display control device configured to sequentially extract images of the display ranges from the page image and displays the images on the display device in accordance with the shift sequence information in the collateral information of the digital comic data received by the reception device;
a mode switch instruction input device configured to receive a switch instruction input to switch between the entire region display mode and the key region display mode, wherein
the display control device sequentially displays the entire region of the page image on the display device in the case of the entire region display mode, and sequentially displays the display ranges including the key region on the display device based on the collateral information of the digital comic data in the case of the key region display mode.

20. A display control method for displaying a digital comic on a display device having a predetermined screen size, the display control method, comprising the steps of:
acquiring a piece of digital comic data which includes a page image of each page of a comic and a piece of collateral information corresponding to each page or all pages of the comic,
the collateral information including, as a piece of region information of a key region, at least one of:
a piece of text region information representing a text region in which text is written within the page image;
a piece of speech bubble region information representing a speech bubble region drawn with a speech bubble within the page image; and
a piece of interest region information representing an interest region drawn with an interest object of the comic within the page image,
determining a shift sequence in which display ranges corresponding to the screen size of the display device are shifted sequentially within the page image of the digital comic data, and determining the shift sequence to sequentially display the display ranges including the key region on the display device based on the collateral information of the digital comic data; and
sequentially extracting the images of each display range from the page image in accordance with the shift sequence of the display ranges determined by the shift sequence determination step to display the images on the display device.

21. A digital comic editing method for editing a piece of digital comic data which includes a page image of each page of a comic and a piece of collateral information corresponding to each page or all pages of the comic,
the collateral information including, as a piece of region information of a key region, at least one of:
a piece of text region information representing a text region in which text is written within the page image;
a piece of speech bubble region information representing a speech bubble region drawn with a speech bubble within the page image; and
a piece of interest region information representing an interest region drawn with an interest object of the comic within the page image,
the digital comic editing method comprising the steps of:
acquiring the digital comic data;
determining a shift sequence in which display ranges corresponding to the screen size of the display device are shifted sequentially within the page image of the digital comic data, and determining the shift sequence to sequentially display the display ranges including the key region on the display device based on the collateral information of the digital comic data; and
performing information editing to write a piece of shift sequence information representing the shift sequence determined by the shift sequence determination device into the collateral information of the digital comic data.

22. A non-transitory computer-readable medium storing a program causing a computer unit to execute the display control method set forth in claim 20.

23. A non-transitory computer-readable medium storing a program causing a computer unit to execute the digital comic editing method set forth in claim 21.
